(19) United States
(12) Patent Application Publication
(10) Pub. No.: US 2007/0143300 A1
(43) Pub. Date: Jun. 21, 2007

(54) System and method for monitoring evolution over time of temporal content

(75) Inventors: Antonino Gulli, Pisa (IT); Filippo Tanganelli, Castiglioncello (LI) (IT); Antonio Savona, Sora (FR) (IT)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Ask Jeeves, Inc.

(21) Appl. No.: 11/313,584

(22) Filed: Dec. 20, 2005

(51) Int. Cl. G06F 17/30

(52) U.S. Cl. 707/10

(57) ABSTRACT

A method and a system to receive temporal content from many sources over a transmission line, store the temporal content in at least one storage device, extract entity content from the temporal content, analyze entity occurrences to determine temporal content trends, receive a search query from a user, and render personalized temporal content to the user based on the temporal content trends.

### FIELD OF THE INVENTION

Exemplary embodiments relate generally to the technical field of data searching and, in one exemplary embodiment, to methods and systems to monitor evolution of content streams to detect and correlate fresh topics.

### BACKGROUND OF THE INVENTION

The World Wide Web (the “Web”) provides a breadth and depth of information to users. Typically, a user accesses portions of the information by visiting a Web site. As a result of a desire by users to search for relevant Web sites related to the users' topics of interests, some Web sites provide search engines that allow users to provide one or more search terms or keywords.

Once a user enters one or more search terms or keywords, the search engine provides search results based on the search terms or keywords. Typically such search results include a list or one or more Web sites or other locations or Uniform Resource Locators (URLs) that may be related to the search terms or keywords. The list may include one or more links to the Web sites, locations, URLs, etc. in search results that the user can select or “click” on. Thus, the user can decide which navigation path to follow by deciding which of the Web sites, locations, URLs, etc. to go to.

When a user is searching for a topic or news item, typical search engines simply return lists, links, or articles solely based on the search terms. That is, no matter what relationship the terms may have, the search engines only return content that includes the search terms. Therefore, a user must still wade through the returned content and determine what content is important to them.

### SUMMARY

One embodiment includes a system with a first storage device connected to a transmission line, an entity extractor unit to render entity content, a second storage device connected to the entity extractor unit, a trend analyzer unit is connected to the second storage device, a plurality of servers are coupled to a wide-area network and the trend analyzer, and at least one client communicates with the wide-area network. The at least one client has a browser to transmit content requests to the plurality of servers and to render trend-based content returned in response to the requests.

Another embodiment includes a system with a plurality of servers connected to a wide-area network having temporal content trend information and entity content stored in at least one storage device. A plurality of clients communicate with the wide-area network over a communications medium. The plurality of clients have varying locations. The system further having means for generating temporal content data based on a plurality of temporal content trends for each of the plurality of clients. The plurality of clients each have a hyperlink browser to send HTTP requests to the plurality of servers and to render personalized temporal content returned in response to the HTTP requests.

Yet another embodiment includes a method that receives temporal content from a plurality of sources over a transmission line, stores the temporal content in at least one storage device, extracts entity content from the temporal content, analyzes entity occurrences to determine temporal content trends, receives a search query from a user, and renders personalized temporal content to the user based on the temporal content trends.

Still another embodiment includes a machine-accessible medium containing instructions that, when executed, cause a machine to: store temporal content received from a plurality of sources in at least one storage device, extract entity content from the temporal content, and analyze entity occurrences to determine temporal content trends.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1A-B illustrates an embodiment of a system diagram including a client-server architecture;

FIG. 2 is a block diagram of a process to render content based on trends;

FIG. 3 illustrates an embodiment of a system for determining and using content trends;

FIG. 4 illustrates a selected display showing trend of entity content over a period of time;

FIG. 5 illustrates an example display of correlations for entities;

FIG. 6 illustrates example pie chart displays showing different categories for entities;

FIG. 7A illustrates an example of a display of a user personal watch list;

FIG. 7B illustrates an example of a partial display list of gainer trends for different entities;

FIG. 7C illustrates an example of a partial display list of loser trends for different entities;

FIG. 8 illustrates an embodiment of a user display giving a user options for a searched entity;

FIG. 9 illustrates a graph showing ping-pong clustering;

FIG. 10 illustrates a diagrammatic representation of an embodiment of a machine in the exemplary form of a computer system;

FIG. 11 illustrates an embodiment of a user display for a global watch list; and

FIG. 12 illustrates an embodiment of a user display for a selecting time windows and country.

### DETAILED DESCRIPTION

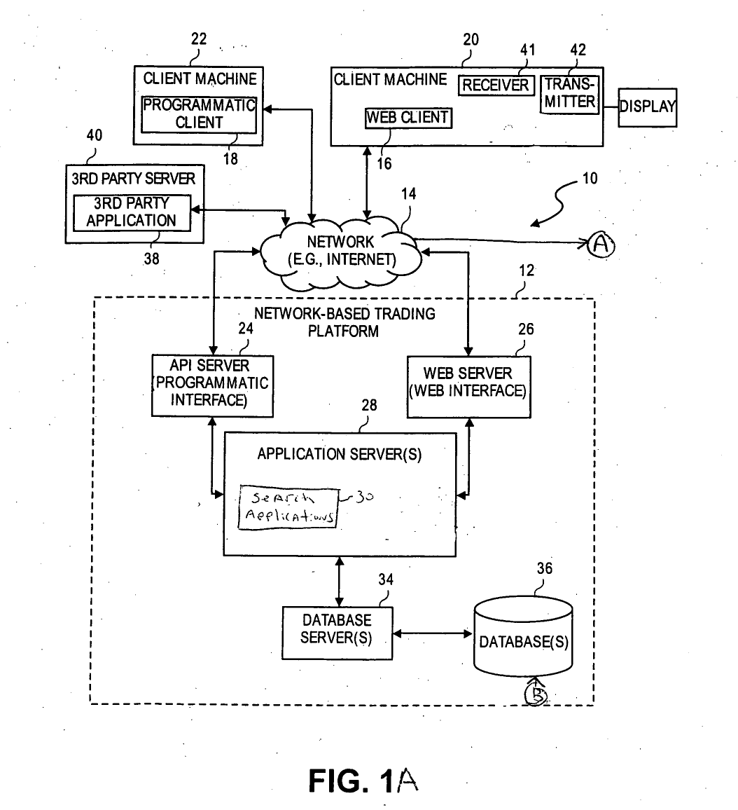

FIG. 1A-B is a network diagram depicting a system 10, according to one exemplary embodiment, having a client-server architecture. A search platform, in the exemplary form of a network-based search platform 12, provides server-side functionality, via a network 14 (e.g., the Internet) to one or more client machines 20 and 22. FIG. 1A-B illustrates, for example, a web client 16 (e.g., a browser, such as the INTERNET EXPLORER browser developed by Microsoft Corporation of Redmond, Washington State), and a programmatic client 18 executing on respective client machines 20 and 22.

Turning specifically to the network-based search platform 12, an Application Program Interface (API) server 24 and a web server 26 are connected to, and provide programmatic and web interfaces respectively to, one or more application servers 28. The application servers 28 host one or more search applications 30. The application servers 28 are, in turn, shown to be coupled to one or more database servers 34 that facilitate access to one or more databases 36.

The search applications 30 provide a number of search functions and services to users that access the search platform 12. Further, while the exemplary system 10 shown in FIG. 1 employs a client-server architecture, the present invention is of course not limited to such an architecture, and could equally well find application in a distributed, or peer-to-peer, architecture system. The various search applications 30 could also be implemented as standalone software programs, which do not necessarily have networking capabilities.

The web client 16, it will be appreciated, may access the various search applications 30 via the web interface supported by the web server 26. Similarly, the programmatic client 18 may access the various services and functions provided by the search applications 30 via the programmatic interface provided by the API server 24.

FIG. 1A-B also illustrates a third party application 38, executing on a third party server machine 40, as having programmatic access to the network-based search platform 12 via the programmatic interface provided by the API server 24. For example, the third party application 38 may, utilizing information retrieved from the network-based search platform 12, support one or more features or functions on a website hosted by the third party. The third party website may, for example, provide one or more promotional, search functions that are supported by the relevant applications of the network-based search platform 12.

The client machine 20 also includes a receiver 41, transmitter 42 and a display 45. The receiver 41 wirelessly may for example receive data/information and transmitter 42 transmits data/information wirelessly. The client machine 20 may be mobile, such as disposed in a vehicle, a notebook computer, a personal digital assistant (PDA), a cellular telephone, etc. The receiver 41 may be capable of receiving information/data/voice/video content, for example from network 14. The transmitter 42 may be capable of transmitting information/data/voice/video content to, for example network 14. The display 45 can be any type of display capable, for example, of displaying graphical/video/images/text. A user interface may also be coupled to client machine 20. The user interface may be a keyboard, resistive digitizer (e.g., touchscreen), mouse, microphone/speaker(s), etc.

FIG. 1A-B further illustrates remote site 43 through remote site N 44 that communicate through network 14. Focused crawler 45 searches network 14 for temporal content and stores the temporal content in mass storage device 46. Indexer 47 indexes the temporal content into database 36.

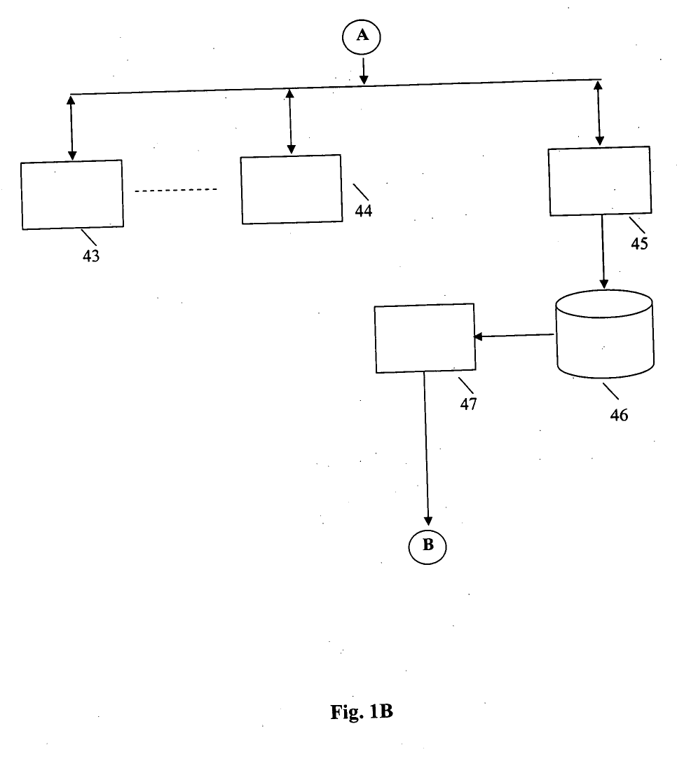

FIG. 2 illustrates a block diagram of an embodiment of a process. Process 200 begins with block 210 where temporal content (i.e., content associated with a date and time), such as news content, is received twenty four (24) hours a day, seven (7) days a week over a transmission line (e.g., Internet) from many news/story/articles/blogs/email, Web pages (crawled with a time stamp), RSS/Atom feeds, desktop searching (associated with a time stamp), converted speech from radio/televised, etc. content sources (e.g., 800+ sources) from multiple countries, e.g., United States, Italy, United Kingdom). The content is searched and retrieved by tunable crawlers that run at set intervals, e.g., every 15 minute, 20 minutes, 30 minutes, etc. Content includes text, graphics, video, audio, hypertext, and uniform resource locator (URL) data. In one embodiment, only the title, excerpt and available image from a news article. Blog websites, publications, etc. are additionally searched for content. In block 220, the received content is stored in a storage device, such as a redundant array of independent disks (RAID) or other mass storage device.

In block 230 entity content is extracted from the stored content, such as news content. Entity content includes names, class (e.g., person, place, location, thing, organization, celebrity, sport-star, books, songs, topic (e.g., politics, world news, local news, entertainment, sports, generic (i.e., no category), etc.), date, URL to original story/article and name of the source of the story/article, part of speech, goods sold, etc. The entity set of each story/article is stored in a searchable index. Entity content is extracted, in parallel, from a static list of predetermined entities (e.g., NASDAQ top 100, Celebrities, etc.), dynamically changing entities (e.g., names, places, organizations, etc.), and name lists, such as domain name lists, etc. In another embodiment, recurring terms, recurring sentences, sub-sequences of non adjacent words are extracted as entity content. The recurrent terms, sentences, etc. can be weighted according to their frequency in the stream of content. Known weighting measures can be used (e.g., TF-IDF). The recurring terms, sentences, etc. can be weighted according to their frequency in a Web index using known weighting techniques. The recurring terms, sentences, etc. can be extracted using NLP techniques, such as named entities, or part of speech, etc. The extracted entities are then stored in a mass storage device, such as a RAID.

In block 240, entity occurrences are analyzed to determine the evolution of an entity over time (i.e. trend). Gainers and losers are identified using a number of occurrences in consecutive time frames. Gainers are content (e.g., “news facts”) that have a rapid increase in occurrences in a given consecutive time frame. The top gainers are determined based on all entities extracted in two consecutive time frames, those that appear in the two time frames and have the most rapid increase in number of occurrences between the previous time frame and the current time frame. Losers are content (e.g., “news facts”) that are losing importance. That is, losers have the number of occurrences in consecutive time frames diminishing. The entity occurrences are analyzed for reoccurrences over a window of time (e.g., half a day, a day, a week, etc.). For any reoccurrence a counter is incremented, and the date of the reoccurrence and the news source that produced the recurrence are stored in a database in the mass storage device. Additional information is stored for the recurrence, such as category, language, etc.

If two pieces of information co-occurred in the same news article, their similarity increases. In one embodiment, fresh trends are discovered as follows. The set S_{Ω}={e₁, e₂, e₃, . . . , eₙ} of entity content are extracted for a fixed window of time=[t, t+δ). The number of times that the extracted content appears in Ω is represented by Occ_{Ω}(eᵢ). And, Occ_{Ω-1}(eᵢ) is the number of times that the entity content eᵢ appears in Ω−1=[t−δ, t). The fresh trends are discovered by selecting the top fixed K entity content or the top weighted entities for a given minimum threshold, which increase (i.e., gainer) or decrease (i.e., loser) the number of appearances in two adjacent time windows Ω and Ω−1. It should be noted that other temporal methodologies for detecting fresh trends can also be used.

In block 250, a user enters a search query using a search engine that searches the extracted entities. In block 260, the search engine returns personalized newspaper web page where news sharing the same fresh topic are clustered together and the user can monitor the evolution of the clusters over time, with fresh news articles entering into the cluster and old news articles expiring.

The new trends and the new topics discovered are used to improve the clustering of search results provided by the search engine with fresh information. The measure of similarity is used for discovering when a piece of information P1 is similar to a piece of information P2 over a time window T. In one embodiment a clustering algorithm is used to cluster together different pieces of information over the time window Ω. For example, suppose that a user submits a query Q to the search engine, at time T contained in Ω. Suppose that Q is contained in the cluster C, then any other piece of information contained in C can be interesting for the user. When the time window Ω expires, the information in C is considered as no longer valid for the user submitting Q.

New trends and topics discovered are clustered to discover fresh and dynamic relations between them. For Example, at one instance of time the entity “George Bush” can be correlated to “Iraqi Constitution” and this correlation can last for a certain period of time. Then a new correlation can arise, for example “George Bush” and “Hurricane Katrina”. In one embodiment, clustering is realized by a ping-pong cluster algorithm between the news articles space and the recurrences space. Starting with a given entity recurrence e, the set S^{π} (e) of all the documents containing e, in a given window of time π, is retrieved. The set Corr(e) of most frequent entity recurrences in S^{π} (e), which are above a threshold t, are considered as correlated to e. This process is iterated several times to compute Corr⁽²⁾(e)=Corr(Corr(e)), . . . for a fixed number of iterations or until Corr^{(k-1)}(e)=Corr^{(k)}(e).

The process of clustering between events (i.e., a fast rising trend or top-gainer) is also described by using a bipartite graph G_{Ω}=(N1_{Ω}U N2_{Ω}, E) where the set of nodes N1 represent the portion of stream seen in the time window Ω, while the nodes N2 represent the event extracted during the observation time window Ω. An edge (n, m) ε E if and only if the entity m has been extracted by the content n. In one embodiment a graph clustering algorithm is applied over G_{Ω} for discovering fresh correlation between trends.

Fresh URLs with top gainers and losers discovered can be used to populate a fresh index of the search engine. New trends and topics discovered are associated to the fresh hyperlinks. For example, suppose that the entities E1, E2, . . . En are extracted from the content (e.g., news article) A, and suppose that these entities are judged as a fresh trend (i.e., gainer or loser), and suppose that fresh hyperlinks H1, H2, . . . Hp are extracted from A. In this example the Web pages denoted by H1, i=1, . . . , p can be tagged with the entities E1, E2, . . . En. The URLs are selected based on the increase or decrease in occurrences in consecutive time frames.

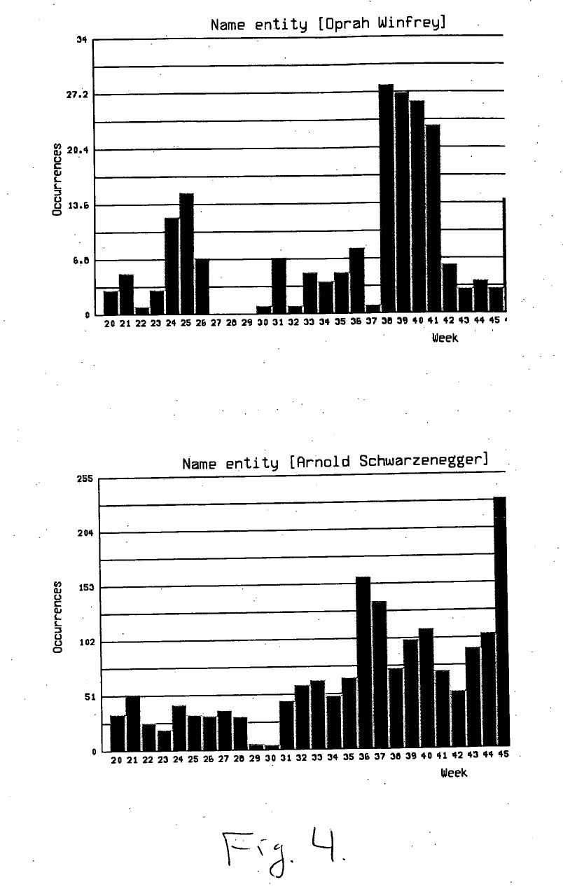

A multilayer graph is used for a display to the user. In this embodiment a first layer is the Web Graph layer when nodes are Web pages and edges are the hyperlinks. A second layer consists of fresh topics extracted from the news layer (See FIG. 5). For example, fresh trends represented by the entities E1, E2 are associated to the content N1 in a time of window Ω, which contains the fresh links H1 pointing to Web page WP1. The entities E1 and E2 are associated to WP1 for a certain period expressed as function of the time window f (Ω).

Correlated top gainer events can be used to improve the ranking of search engines and predicting search trends. This is used for adding freshness to the Web index. Those Web pages that contain fresh topics—identified over the stream of news—are boosted in ranking for the period of observation. After a certain amount of time (e.g., a week, a month, etc.), if the topic is no longer fresh the boosting effect is subject to a decay rule.

Correlated top gainer events are suggested to users to expand their search query over the recurrence space (see FIG. 5). This eases searching for users as the search is focused or targeted.

The new trends and the new topics discovered are used to maintain an updated dictionary of speech to text system, where new terms are inserted and removed as soon as they appear or expire from the stream of content.

Entity content or portions of content that are not assigned a class has a class predicted for the content or portions of content. Some sources of the stories/articles manually associate a class with the stories/articles. The stories/articles that have been assigned a class are used to train a classifier to predict a class for entity content that does not have an associated class. Classes can be predefined or user defined. Class categories can be static or can evolve dynamically. Dynamic category evolution adds new terms automatically and discards old terms. The new terms are added when new trends are discovered and the old terms are discarded when the older trends lose importance. In one embodiment a modified Bayesian classifier or support vector machine (SVM) classifier can be used as an evolving classifier.

The results of assigning classes are used to create ways to search for related information by class. That is, multiple entity content can exist for a search term. Each of the entity content can be assigned varying classes. Percentages of each class assigned to the entity content can be determined. For example, for a specific search term, 100 entities are extracted. The classes for the entities can be assigned as follows: 10% for politics, 40% top news, 30% national stories, 15% generic (i.e., no category), 2% for entertainment, 1% for business, 2% world news. In this example, a user can search in specific classes to narrow their search. In one embodiment, a pie chart can be drawn on a search web page illustrating the class percentages for entity content for a specific search term. In this embodiment, a user can select the portion of the pie chart to return the clustered entity content for the search term in the particular class.

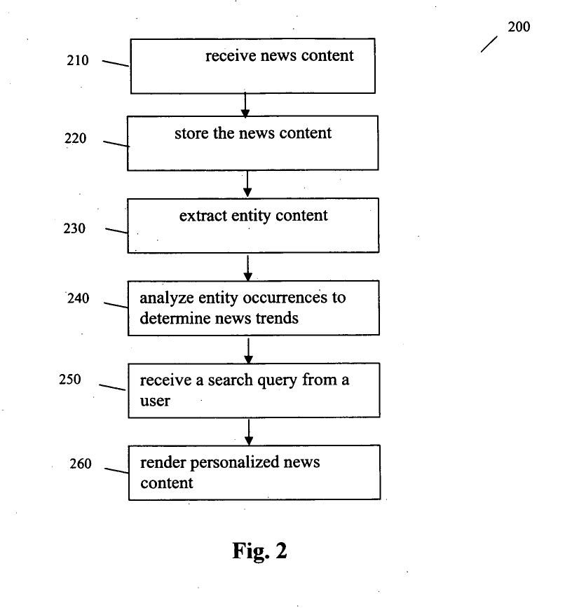

FIG. 3 illustrates an embodiment of a system for determining and using news trends. System 300 includes sources of content 310. The content is received twenty four (24) hours a day, seven (7) days a week over transmission line 305 (e.g., Internet) from many websites/news sources/stories/articles/blogs/videos/etc. content sources (e.g., 800+ sources) from multiple countries, e.g., United States, Italy, United Kingdom). The news content is searched and retrieved by tunable focused crawler(s) 390 that run at set intervals, e.g., every 15 minute, 20 minutes, 30 minutes, etc. News content includes text, graphics, video, audio, hypertext, and uniform resource locator (URL) data. The title, excerpt and available image from content (e.g., time-stamped content) can be stored. The received content is stored in storage device 320, such as a redundant array of independent disks (RAID) or other mass storage device. As illustrated, the arrows indicate the flow of the content streams.

Discovered trends can be used for setting prices in an advertising selling scheme setup as an auction. The starting price for advertising, such as advertising on a Web page associated with top gainers, is set once the new trend is discovered by temporal trend analyzer 345. Clustering/correlation of entities is performed by clustering unit 380 and is used to set a price for the group of clustered or correlated entities. Classification of prices is used according to predicted categories.

Entity extractor unit 330 entity content is extracted from the stored news content. In one embodiment, multiple extractor units 330 operate in parallel to extract entity content from the content stored in storage device 320. In one embodiment, entity content includes names, class (e.g., person, place, location, thing, organization, celebrity, sport-star, books, songs, topic (e.g., politics, world news, local news, entertainment, sports, generic (i.e., no category), etc.), date, URL to original story/article and name of the source of the story/article. In one embodiment, the entity set of each story/article is stored in a searchable index. In another embodiment, entity content is extracted, in parallel, from a static list of predetermined entities (e.g., NASDAQ top 100, Celebrities, etc.), dynamically changing entities (e.g., names, places, organizations, etc.), and name lists, such as domain name lists, etc. In another embodiment, recurring terms, recurring sentences, sub-sequences of non adjacent words are extracted as entity content. The extracted entities are then stored in storage device 340, where storage device 340 is a mass storage device, such as a RAID.

Temporal trend analyzer 345 analyzes entity occurrences to determine new content trends. Gainers and losers are identified using the number of occurrences in consecutive time frames. Gainers are “news facts” that are gaining importance in a given time frame (e.g., a day, a week, a month, etc.). In this embodiment, losers are “news facts” that are losing importance. The entity occurrences are analyzed for reoccurrences over a window of time (e.g., half a day, a day, a week, etc.). For any reoccurrence a counter is incremented, and the date of the reoccurrence and the content source that produced the recurrence are stored in a database in storage device 340. Additional information is stored for the recurrence, such as category, language, etc.

Focused crawler(s) 390 uses the new trends found from trend analyzer 345 to better focus. For example, when blog sites start to discuss an unanticipated (i.e., emergency, unforeseen event, earthquake, tsunami, terrorist activity, etc.) event, the new topic is an indication that more users may be interested in and have a desire to receive more information on the unanticipated event. Focus crawler(s) 390 can then focus in on web objects collected and related to the topic. When the interest in the topic diminishes, focus crawler(s) 390 can re-organize an internal index in order to reflect the change. Anticipated events (i.e., elections, opening day for movies, stores, scheduled sports events, etc.) are also used for focused crawling.

A user enters a search query using a search engine, such as search engine 370 that searches the extracted entities. Search engine 370 in connection with trend analyzer 345 stores search queries and analyzes trends in search terms. The search terms are clustered with entity content by clustering unit 380 to predict possible related search terms. The predicted search terms are offered to a user as optional search terms in a graphical user interface (GUI) display.

News engine 360 returns a personalized newspaper web page where content/news sharing the same fresh topic are clustered together by clustering unit 380 and the user can monitor the evolution of the clusters over time, with fresh content/news articles entering into the cluster and old content/news articles expiring.

Entity content or portions of content that are not assigned a class has a class predicted for the content or portions of content by classifier unit 335. Some sources of the stories/articles manually associate a class with the stories/articles. The stories/articles that have been assigned a class are used to train classifier unit 335 to predict a class for entity content that does not have an associated class. Classes can be predefined or user defined. Class categories can be static or can evolve dynamically. Classifier unit 335 includes a modified Bayesian classifier or support vector machine (SVM) classifier that is used as an evolving classifier.

The results of assigning classes are used to create ways to search for related information by class. That is, multiple entity content can exist for a search term. Each of the entity content can be assigned varying classes. Percentages of each class assigned to the entity content can be determined. For example, for a specific search term, 100 entities are extracted. The classes for the entities can be assigned as follows: 10% for politics, 40% top news, 30% national stories, 15% generic (i.e., no category), 2% for entertainment, 1% for business, 2% world news. In this example, a user can search in specific classes to narrow their search. A pie chart can be drawn on a search web page illustrating the class percentages for entity content for a specific search term. A user can select the portion of the pie chart to return the clustered entity content for the search term in the particular class.

New trends and the new topics discovered are used to maintain an updated dictionary of speech to text unit 350, where new terms are inserted and removed as soon as they appear or expire from the stream of content. Typical speech to text programs can be used to convert speech to text. Radio speech content and televised speech content are converted to text. The converted text are used to find fresh trends as discussed above.

Language identifier unit 395 identifies language of the content. Language identifier unit can be trained to identify certain words that distinguish languages. Multiple stored words are then compared with words in content. When a match is found, the language identifier has determined the language and sets a flag/variable for trend analyzer 345.

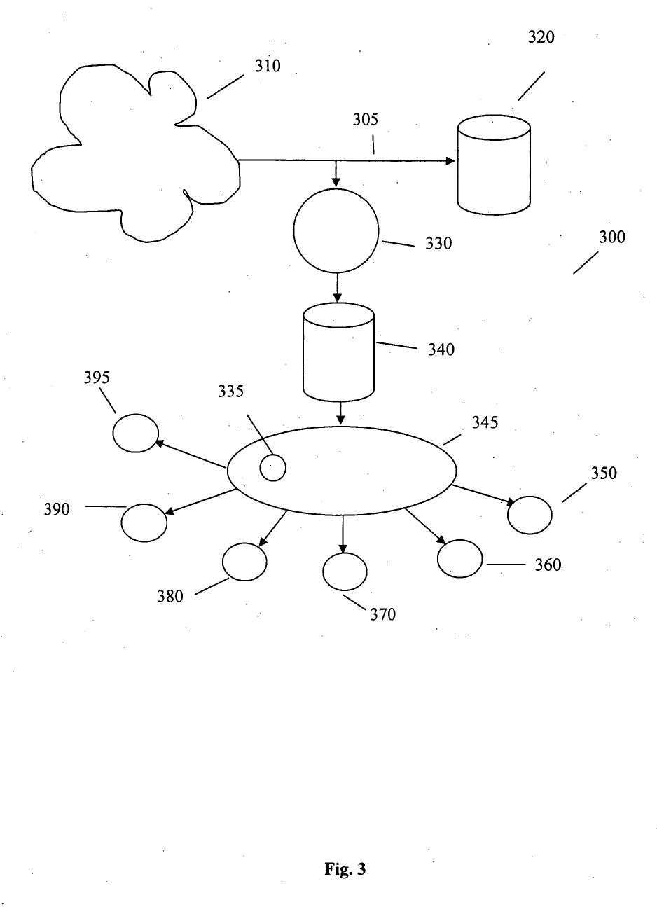

FIG. 4 illustrates a selected display that is a result of trend analyzer 345 analyzing entity content over a period of weeks. As illustrated, each topic or search term results in varying occurrences per week. Anticipated events are foreseen and can be used to preset time frames. Unanticipated events are identified based on peak occurrences as well. As a user can see time frames having peak occurrences, a user can select a focused period for which to return entity content.

FIG. 5 illustrates correlations for the entities Arnold Schwarzenegger and Oprah Winfrey that are displayed for a user. The recent correlations display the number of occurrences, dates of occurrences and hyperlinks to other entities for content published within a certain period of time that can be user selectable. Recent correlations change with time based on the published date and time frame. A user can expand a search to include further search terms by selecting the “Expand your search” link. A “last” correlations display does not have a time period for published content. The “last” correlations display displays the latest content regardless of publishing date.

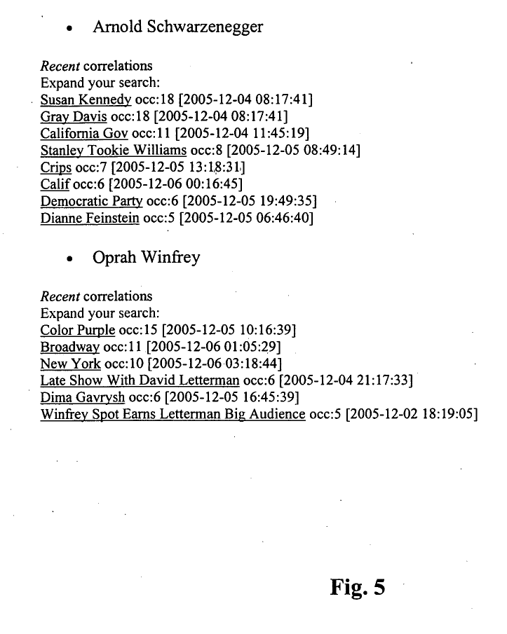

FIG. 6 illustrates pie charts that are selectable by a user. The pie charts are displayed and the different categories are displayed in different colors. A user can choose the category for each entity to narrow their search. As illustrated, the entities Barry Diller and Madonna have content occurrences in different categories. In one embodiment, a user can “click” on a section of the pie and receive the results of the content for the entity and category.

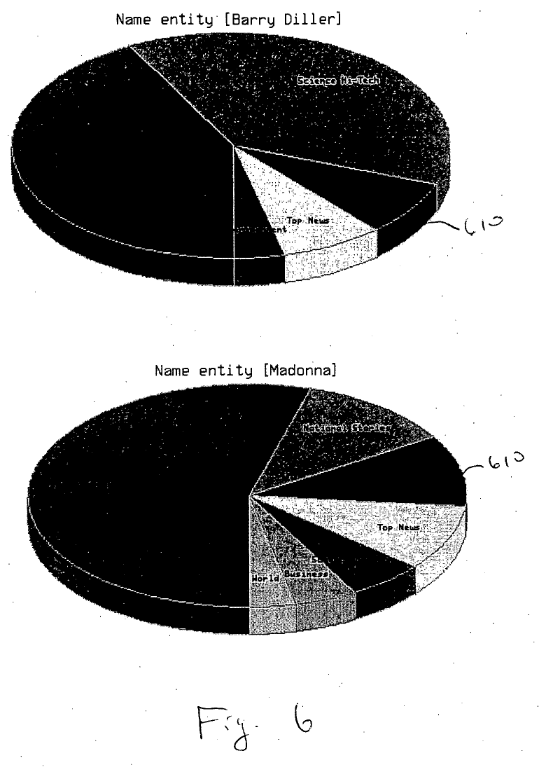

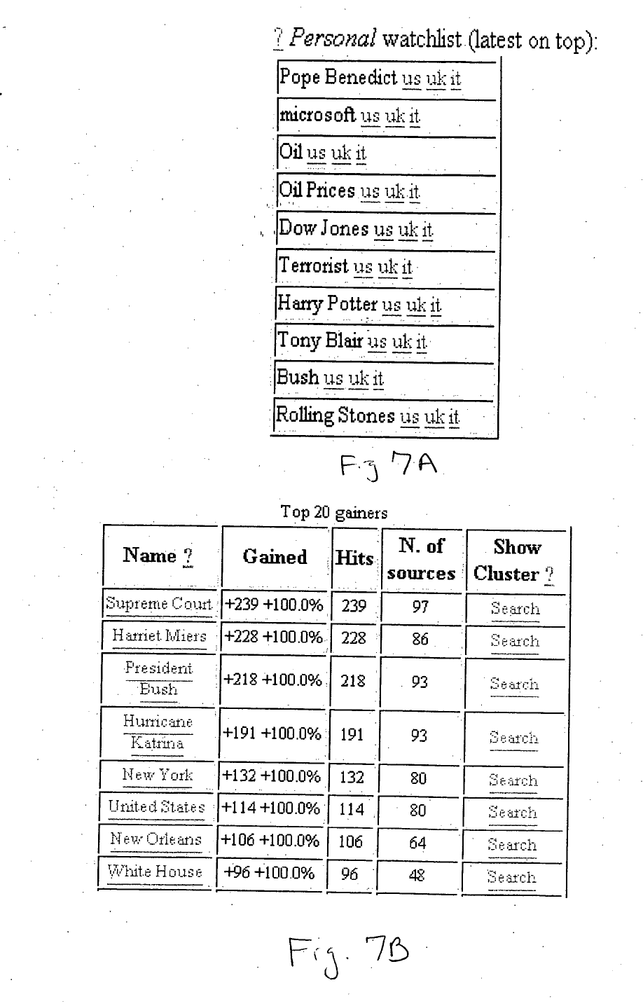

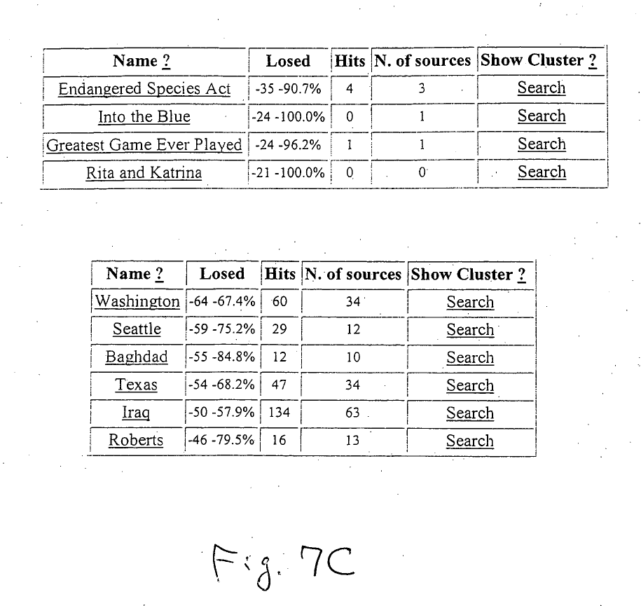

FIG. 7A illustrates a display of a user personal watch list for fresh trends. As illustrated, the watch-list includes a list of ten (10) entities based on the user's recent selected entities, with choice of country for each entity. The watch-list takes into account the last trends selected by that user. The entity with the most recent occurrence is displayed on the top of the watch-list. It should be noted that other embodiments include more or less entities depending upon the user's choice.

FIG. 7B illustrates a partial display list of gainer trends for different entities. The display includes trend percent gain, number of occurrences (hits), number of sources and a selectable link for showing the cluster. In one embodiment the user can select from the top ten, top twenty, etc. gainers to display. FIG. 7C illustrates a display list of loser trends for different entities. In this embodiment, the display includes the percent of trend loss, number of occurrences (hits), number of sources and a selectable link for showing the cluster. In one embodiment the user can select from the top ten, to twenty, etc. losers to display.

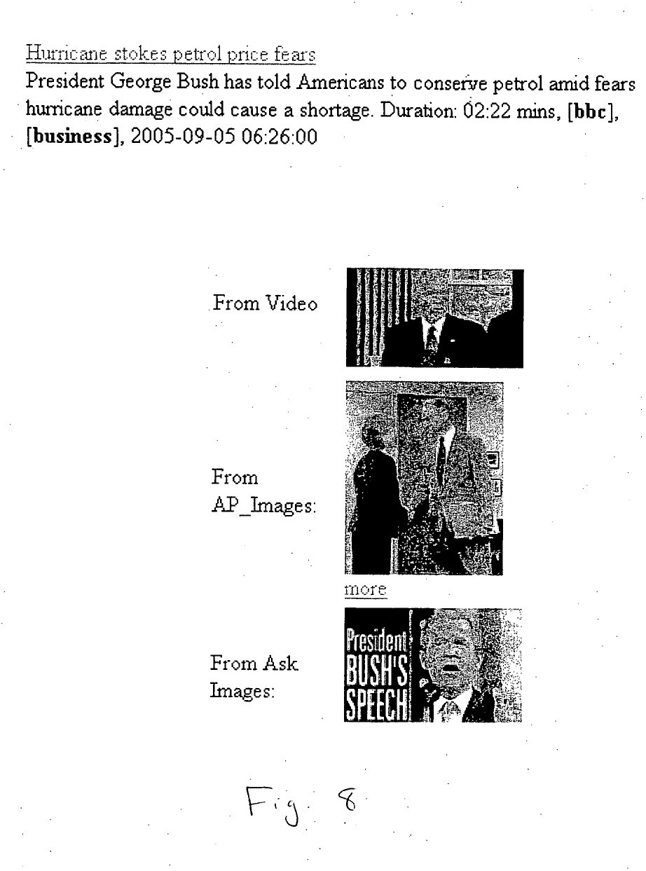

FIG. 8 illustrates an embodiment of a user display giving a user options for a searched entity. In this embodiment, the graphics or video entity display includes title of entity that is also a hyperlink, summary of entity, duration of complete content, source, class, date and time, and user selectable video or graphics. In this embodiment, a user can select the “From Video” to display the video content, or select either From AP_Images or Ask Images to display still graphic images.

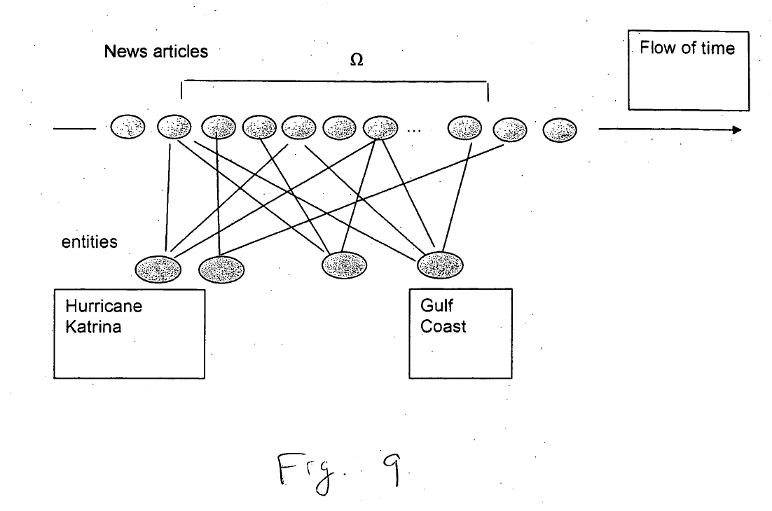

FIG. 9 illustrates a graph showing ping-pong clustering. The displayed graph G_{Ω}=(N1_{Ω} U N2_{Ω}, E) where the set of nodes N1 represent the portion of the content stream seen ion the time window Ω. An edge (n,m) ε E if the entity m has been extracted by the news article n.

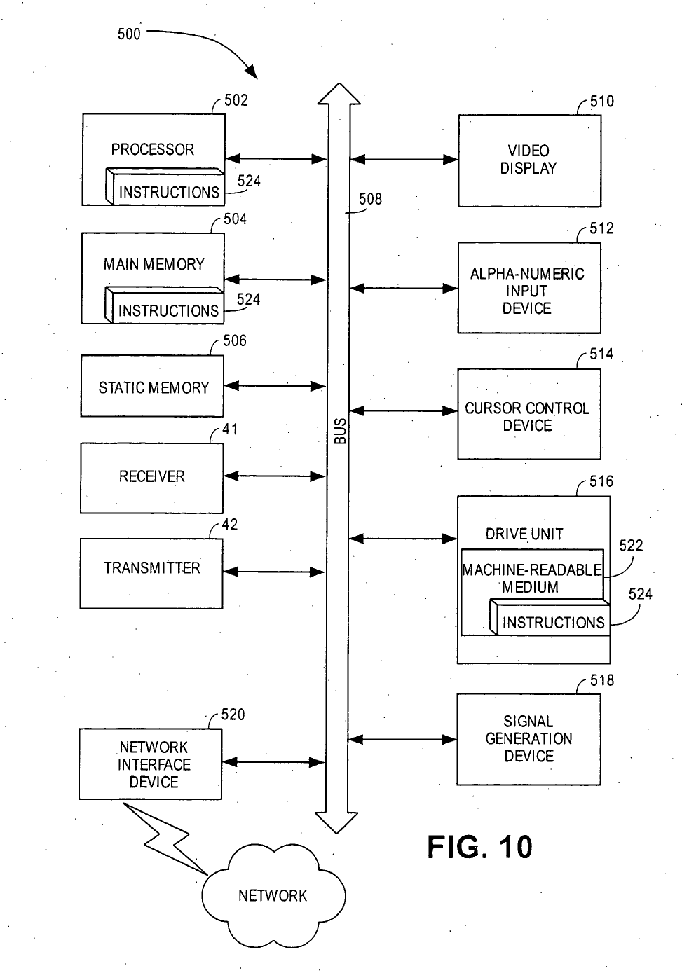

FIG. 10 shows a diagrammatic representation of machine in the exemplary form of a computer system 500 within which a set of instructions, for causing the machine to perform any one or more of the methodologies discussed herein, may be executed. In various embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment.

The machine may be a server computer, a client computer, a PC, a tablet PC, a set-top box (SIB), a PDA, a cellular (or mobile) telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processor 502 (e.g., a central processing unit (CPU), a graphics processing unit (GPU) or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media.

The software 524 may further be transmitted or received over a network 526 via the network interface device 520. In one embodiment, receiver 41 and transmitter 42 (see FIG. 1) are coupled to bus 508.

While the machine-readable medium 526 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present invention. The machine-readable medium includes any mechanism that provides (i.e., stores and/or transmits) information in a form readable by a machine (e.g., a computer, PDA, cellular telephone, etc.). For example, a machine-readable medium includes read-only memory (ROM); random-access memory (RAM); magnetic disk storage media; optical storage media; flash memory devices; biological electrical, mechanical systems; electrical, optical, acoustical or other form of propagated signals (e.g., carrier waves, infrared signals, digital signals, etc.). The device or machine-readable medium may include a micro-electromechanical system (MEMS), nanotechnology devices, organic, holographic, solid-state memory device and/or a rotating magnetic or optical disk. The device or machine-readable medium may be distributed when partitions of instructions have been separated into different machines, such as across an interconnection of computers or as different virtual machines.

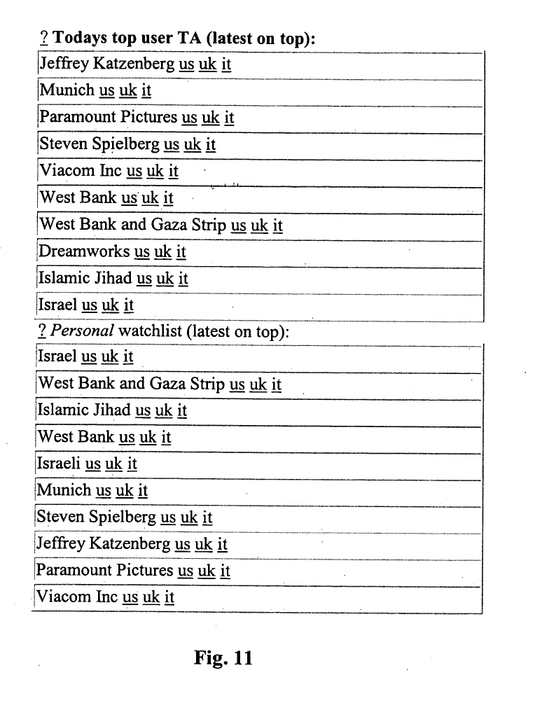

FIG. 11 illustrates a display of a global watch list for fresh trends. As illustrated, the global watch-list includes a list of ten (10) entities with choice of country for each entity. The global watch-list takes into account the last trends that occur the most for all users combined. The entity with the most recent occurrence is displayed on the top of the global watch-list. It should be noted that other embodiments include more or less entities. As illustrated, a user can display their personal watch-list along with the global watch-list on the same display. This allows a user to see what the majority of other user's are searching for or are interested in.

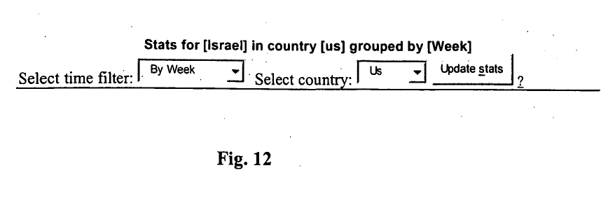

FIG. 12 illustrates a display for changing the time frame and country. With this display, a user can select an entity and country and focus their search or scope of interest based on different time frames.

Thus, a method and system to have been described. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Accordingly, the specification and drawings are to be regarded in an illustrative rather than a restrictive sense.

What is claimed is:

1. A computer network system comprising:
a first storage device connected to a transmission line;
an entity extractor unit to render entity content;
a second storage device connected to the entity extractor unit;
a trend analyzer unit connected to the second storage device;
a plurality of servers connected to a wide-area network and the trend analyzer; and
at least one client to communicate with the wide-area network, the at least one client having a browser to transmit content requests to the plurality of servers and to render trend-based content returned in response to the requests.

2. The system of claim 1, wherein the first storage device stores temporal content.

3. The system of claim 2, wherein the news content comprises text, graphics, video, hypertext and uniform resource locator (URL) data.

4. The system of claim 1, wherein the second storage device stores extracted entity content from the first storage device.

5. The system of claim 1, further comprising:
at least one web crawler coupled to the trend analyzer unit;
a clustering unit coupled to the trend analyzer unit;
a search engine to the trend analyzer unit, the search engine operates to predict trends of queries based on trends of temporal content;
a personalized news engine coupled to the trend analyzer unit;
a speech dictionary coupled to the trend analyzer unit, the speech dictionary includes speech converted to text; and
a language identifier unit coupled to the trend analyzer unit.

6. The system of claim 5, wherein the at least one web crawler is a tuned to crawl based on positive trends in temporal content.

7. The system of claim 1, wherein the entity content comprises:
names data, class data, date data, URL data, location information data, title data and news source data.

8. The system of claim 1, wherein the trend analyzer unit operates to determine trends of temporal content.

9. The system of claim 1, wherein the trend analyzer unit includes a classifier unit, wherein the classifier unit operates to predict a plurality of classes for a plurality of unclassified entity content.

10. The system of claim 9, wherein each unclassified entity content of the plurality of entity content is associated with one or more classes.

11. A system comprising:
a plurality of servers coupled to a wide-area network having temporal content trend information and entity content stored in at least one storage device;
a plurality of clients to communicate with the wide-area network over a communications medium, the plurality of clients having varying locations;
means for generating content data based on a plurality of temporal content trends for each of the plurality of clients;
wherein the plurality of clients each having a hyperlink browser to send HTTP requests to the plurality of servers and to render personalized temporal content returned in response to the HTTP requests.

12. The system of claim 11, wherein the means for generating content data comprises:
an entities extractor unit coupled to the at least one storage device;
a trend analyzer unit coupled to the entities extractor unit;
at least one tunable web crawler coupled to the trend analyzer unit;
a clustering unit coupled to the trend analyzer unit;
a search engine coupled to the trend analyzer unit, the search engine operates to predict trends of queries based on trends of temporal content;
a personalized news engine coupled to the trend analyzer unit;
a speech dictionary coupled to the trend analyzer unit, the speech dictionary includes audio content converted to text; and
a language identifier unit coupled to the trend analyzer unit.

13. The system of claim 12, wherein the temporal content comprises text, graphics, video, hypertext and uniform resource locator (URL) data.

14. The system of claim 12, wherein the trend analyzer unit operates to determine trends of temporal content.

15. The system of claim 12, wherein the trend analyzer unit includes a classifier unit, wherein the classifier unit operates to predict a plurality of classes for a plurality of unclassified entity content.

16. The system of claim 15, wherein each unclassified entity content of the plurality of entity content is associated with one or more classes.

17. A method comprising:
receiving temporal content from a plurality of sources over a transmission line;
storing the temporal content in at least one storage device;
extracting entity content from the temporal content;
analyzing entity occurrences to determine temporal content trends;
receiving a search query from a user; and
rendering personalized temporal content to the user based on the temporal content trends.

18. A machine-accessible medium containing instructions that, when executed, cause a machine to:
store temporal content received from a plurality of sources in at least one storage device;
extract entity content from the temporal content; and
analyze entity occurrences to determine temporal content trends.

19. The machine-accessible medium of claim 18, further containing instructions that, when executed, cause a machine to:
cluster entity content to provide a search engine with a fresh search index.

20. The machine-accessible medium of claim 18, further containing instructions that, when executed, cause a machine to:
cluster entity content to determine fresh and dynamic relations between the clustered entity content.

21. The machine-accessible medium of claim 18, further containing instructions that, when executed, cause a machine to:
cluster entity content, wherein the clustered entity content are uniform resource locators (URLs) to provide a search engine with a fresh search index.

22. The machine-accessible medium of claim 18, further containing instructions that, when executed, cause a machine to:
correlate top gainer events to increase ranking of search engines and to predict search trends.

23. The machine-accessible medium of claim 22, further containing instructions that, when executed, cause a machine to:
suggest correlated top gainer events to users to expand the users' search query over a recurrence space.

24. The machine-accessible medium of claim 18, further containing instructions that, when executed, cause a machine to:
determine category percentiles for entity content;
provide a graphical user interface (GUI) to a user,
wherein the GUI displays the category percentiles and descriptions for the entity content, and the displayed category percentiles are distinguishable and user selectable.

25. The machine-accessible medium of claim 24, further containing instructions that, when executed, cause a machine to:
render a plurality of URLs to a user based on a selected category percentile.

26. The machine-accessible medium of claim 18, further containing instructions that, when executed, cause a machine to:
render a personal watch-list display for a user based on temporal content trends and the user's past temporal content searches.

27. The machine-accessible medium of claim 18, further containing instructions that, when executed, cause a machine to:
render a global watch-list display for a plurality of users based on temporal content trends and the plurality of users past temporal content searches.

28. The machine-accessible medium of claim 18, further containing instructions that, when executed, cause a machine to:
set prices in an advertising selling scheme based on discovered trends.
